(19) United States
(12) Patent Application Publication
(10) Pub. No.: US 2015/0093684 A1
(43) Pub. Date: Apr. 2, 2015

(54) FUEL CELL MEMBRANE WITH CROSSOVER BARRIER

(71) Applicant: Nissan North America, Inc., Franklin, TN (US)

(72) Inventors: Rameshwar Yadav, Farmington, MI (US); Gregory DiLeo, Ann Arbor, MI (US)

(73) Assignee: Nissan North America, Inc., Franklin, TN (US)

(21) Appl. No.: 14/041,153

(22) Filed: Sep. 30, 2013

(51) Int. Cl. H01M 8/04; H01M 8/10

(52) U.S. Cl. CPC H01M 8/04201; H01M 8/10; H01M 8/04089; H01M 2300/0082; H01M 2008/1095
USPC 429/490; 429/535

(57) ABSTRACT

Embodiments of fuel cells and their membrane electrode assemblies are provided, as well as methods for preparing the membrane electrode assemblies. One embodiment of a membrane electrode assembly comprises an anode catalyst layer, a cathode catalyst layer, a polymer electrolyte membrane between the anode catalyst layer and the cathode catalyst layer and a gas barrier layer between the polymer electrolyte membrane and the anode catalyst layer. The gas barrier layer comprises a proton conductive material and is configured to prevent crossover of gas through the polymer electrolyte membrane to the cathode catalyst layer.

### TECHNICAL FIELD

The invention relates to the field of improving fuel cell membrane durability, and in particular to improving membrane durability by reducing gas crossover.

### BACKGROUND

Fuel cells efficiently and electrochemically convert fuel into electric current, which may then be used to power electric circuits, such as drive systems for vehicles. A fuel cell containing a proton exchange membrane is an electrochemical device that converts chemical energy to electrical energy using, for example, hydrogen or methane as fuel and oxygen/air as oxidant. A typical fuel cell membrane electrode assembly includes a solid polymer electrolyte proton conducting membrane between two electrodes.

The electrodes have catalyst used to enhance the rate of the electrochemical reactions which occur at the electrodes. Catalysts typically include noble metals such as platinum carried by a support particle. The membranes are used to provide proton conduction from the anode to the cathode and also to act as a barrier between the fuel and oxidant. Membranes have acid groups that allow proton conduction and also have some week functional groups. These membranes degrade due to chemical attacks from free-radicals on the week functional groups. These free-radicals are formed in the membrane as well as in the electrode from gas crossover. Therefore, there is a need to improve the chemical durability of the membrane used in the PEM fuel cell.

### SUMMARY

Disclosed herein are embodiments of membrane electrode assemblies for a fuel cell. One embodiment of a membrane electrode assembly comprises an anode catalyst layer, a cathode catalyst layer, a polymer electrolyte membrane between the anode catalyst layer and the cathode catalyst layer and a gas barrier layer between the polymer electrolyte membrane and the anode catalyst layer. The gas barrier layer comprises a proton conductive material and is configured to prevent crossover of gas through the polymer electrolyte membrane to the cathode catalyst layer.

Another embodiment of a membrane electrode assembly for a fuel cell disclosed herein comprises an electrode, a hydrocarbon-based electrode, a perfluorosulfonic acid membrane between the electrode and the hydrocarbon-based electrode and a gas barrier layer between the perfluorosulfonic acid membrane and the hydrocarbon-based electrode. The gas barrier layer comprises a proton conductive material and is configured to prevent crossover of gas through the perfluorosulfonic acid membrane to the electrode.

Also disclosed are fuel cells that comprise the membrane electrode assemblies disclosed herein. For example, a fuel cell is disclosed comprising a membrane electrode assembly for a fuel cell comprising an anode electrode, a cathode electrode, a polymer electrolyte membrane between the anode electrode and the cathode electrode and a gas barrier layer between the polymer electrolyte membrane and the anode catalyst layer. The gas barrier layer comprises a proton conductive material. A fuel gas supply is in fluid communication with the anode electrode to provide a fuel gas to the anode electrode and an oxidant supply is in fluid communication with the cathode electrode to provide an oxidant to the cathode electrode. The gas barrier layer is configured to prevent crossover of fuel and oxidant to the cathode electrode and the anode electrode, respectively.

Methods of preparing the membrane electrode assemblies disclosed herein are also provided. For example, a method of preparing a membrane electrode assembly comprises applying a gas barrier layer onto an anode side of a polymer electrolyte membrane, wherein the gas barrier layer is a proton conductive material. An anode electrode is applied onto the gas barrier layer and a cathode electrode is applied onto a cathode side of the polymer electrolyte membrane.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is a schematic cross-sectional illustration of a basic fuel cell stack having multiple gas diffusion electrodes;

FIG. 2 is an enlarged schematic cross-sectional view of a membrane electrode assembly from the fuel cell stack of FIG. 1;

FIG. 3 is a schematic of a fuel cell having an embodiment of a membrane electrode assembly as disclosed herein;

FIG. 4 is a schematic of a fuel cell having another embodiment of a membrane electrode assembly as disclosed herein;

FIG. 5 is a flow diagram of a method of preparing an membrane electrode assembly as disclosed herein;

FIG. 6 is a graph illustrating the amount of gas crossover for a hydrocarbon (HC) membrane, a perfluorosulfonic acid (PFSA) membrane and the prepared PFSA membrane with a gas barrier layer comprising hydrocarbon; and

FIG. 7 is a graph illustrating the chemical durability of each of a hydrocarbon (HC) membrane, a PFSA membrane and the prepared PFSA membrane with a gas barrier layer comprising hydrocarbon under an open circuit voltage (OCV) hold test at 90° C. and 30% RH over 500 hours.

### DETAILED DESCRIPTION

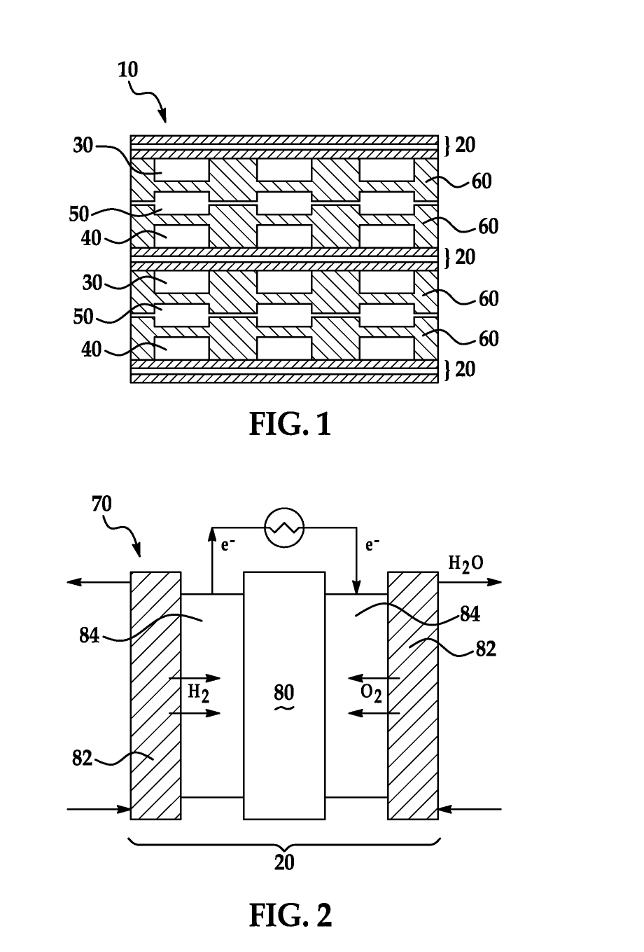

Proton exchange membrane fuel cells are electrochemical devices converting chemical energy to electrical energy by using hydrogen as a fuel and oxygen/air as an oxidant. The proton exchange membrane fuel cell has a fuel cell membrane electrode assembly generally comprising five layers, including a solid polymer electrolyte proton conducting membrane, two gas diffusion layers, and two catalyst layers. FIG. 1 shows a schematic cross-sectional illustration of a portion of a fuel cell stack 10. The illustration is provided as an example of the use of a proton exchange membrane, also referred to herein as a membrane, in fuel cells and is not meant to be limiting.

The fuel cell stack 10 is comprised of multiple membrane electrode assemblies 20. Fuel 30 such as hydrogen is fed to the anode side of a membrane electrode assembly 20, while an oxidant 40 such as oxygen or air is fed to the cathode side of the membrane electrode assembly 20. Coolant 50 is supplied between the fuel 30 and oxidant 40, the coolant 50 separated from the fuel 30 and oxidant 40 by separators 60.

FIG. 2 is an illustration of one of the plurality of fuel cells 70 in the fuel cell stack 10. The fuel cell 70 is comprised of a single membrane electrode assembly 20. The membrane electrode assembly 20 has a membrane 80 with a gas diffusion layer 82 on opposing sides of the membrane 80. Between the membrane 80 and each gas diffusion layer 82 is a catalyst layer 84. The catalyst layer 84 can be formed on the membrane 80. Alternatively, a gas diffusion electrode is made by forming a catalyst layer 84 on a surface of each gas diffusion layer 82 and sandwiching the membrane 80 between the gas diffusion layers 82 such that the catalyst layers 84 contact the membrane 80. When fuel 30, such as hydrogen gas, is introduced into the fuel cell 70, the catalyst layer 84 at the anode splits hydrogen gas molecules into protons and electrons. The protons pass through the membrane 80 to react with the oxidant 40, such as air, forming water (H₂O). The electrons (e⁻), which cannot pass through the membrane 80, must travel around it, thus creating the source of electrical energy.

During operation of the fuel cell 70, it is possible for the oxidant 40 or the fuel 30 to cross over the membrane 80 in small quantities. For example, oxygen may cross over from the cathode to the anode in a hydrogen fuel cell. The crossover oxygen reacts with hydrogen at the anode and generates a mixed potential at the anode leading to a loss of voltage, power and efficiency. In addition, the oxygen can chemically react to form free-radicals such as hydrogen peroxide in the membrane by combining with hydrogen that has crossed over. The hydrogen peroxide generated at the cathode degrades the membrane. The hydrogen peroxide generated at the cathode also combines with metal ion impurities in the carbon based electrocatalyst support used in fuel cells to yield reactive oxygen species (such as free radicals OH) which also accelerate membrane degradation, particularly at low relative humidity and high temperature. The degradation further results in increased gas cross over, which in turn leads to a greater loss of voltage, power and efficiency. Widely used perfluorosulfonic acid membranes have inherently high fuel and oxygen crossover rates due to hydrophobic-hydrophillic nanophase separation. These membranes in particular are vulnerable to chemical degradation and failure.

Much effort is being made to increase the performance and durability of membrane electrode assemblies such as those described with reference to FIGS. 1 and 2. As noted, the condition of the membrane plays an important factor in the performance and durability of the membrane electrode assembly in the fuel cell. The assemblies and methods herein provide improved durability of membrane electrode assemblies.

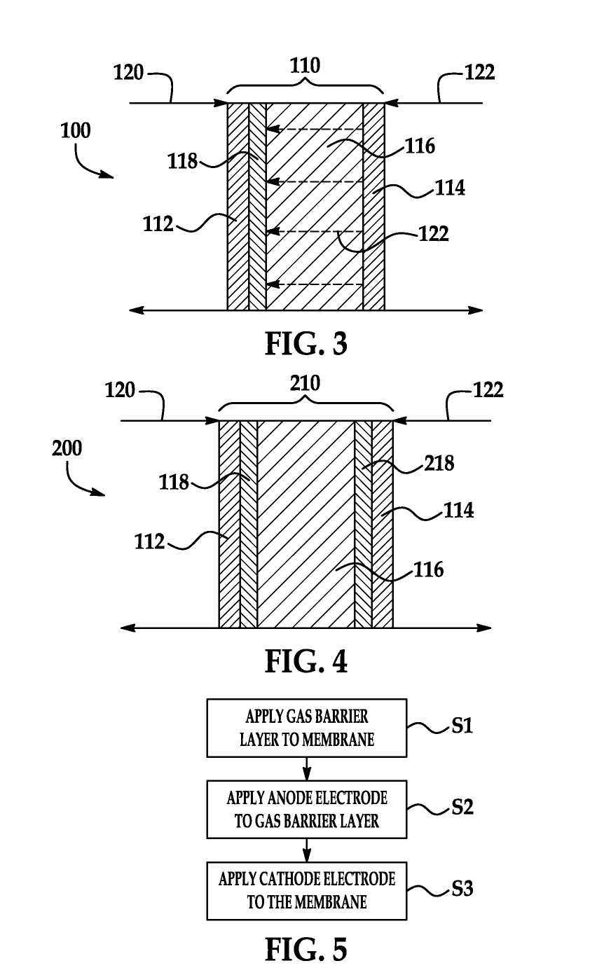

FIG. 3 illustrates one embodiment of a membrane electrode assembly 110 as disclosed herein. The membrane electrode assembly 110 has an anode electrode having an anode catalyst layer 112, a cathode electrode having a cathode catalyst layer 114 and a polymer electrolyte membrane 116 between the anode catalyst layer 112 and the cathode catalyst layer 114. A gas barrier layer 118 is positioned between the polymer electrolyte membrane 116 and the anode catalyst layer 112. The gas barrier layer 118 comprises a proton conductive material and is configured to prevent crossover of gas 120 through the polymer electrolyte membrane 116 to the cathode catalyst layer 114.

As shown in FIG. 3, the fuel cell 100 has a gas supply that supplies gas 120 to the anode side of the membrane electrode assembly 110. The gas 120 does not cross through the gas barrier layer 118 and through the polymer electrolyte membrane 116, and accordingly does not reach the cathode catalyst layer 114. The fuel cell 100 also has an oxidant supply that supplies oxidant 122 to the cathode side of the membrane electrode assembly 110. The gas barrier layer 118 is further configured to prevent oxidant 122 from contacting the anode catalyst layer 112. As illustrated, oxidant 122 can crossover the membrane 116 but is prevented from reaching the anode catalyst layer 112 by the gas barrier layer 118. When the oxidant 122 is air, the gas barrier layer 118 prevents crossover of both oxygen and nitrogen. Although the nitrogen crossover rate is slower than the oxygen crossover rate, nitrogen crossover from the cathode electrode to the anode electrode creates mass transfer limitations to hydrogen transport and diffusion. Therefore, the gas barrier layer 118 can also reduce hydrogen transport resistance.

The gas barrier layer 118 can be incorporated into membrane electrode assemblies having any type of polymer electrolyte membrane 116 known to those skilled in the art. As a non-limiting example, the polymer electrolyte membrane 116 can be a perfluorosulfonic acid membrane.

The gas barrier layer 118 can be made from any proton conductive material known to those skilled in the art that also functions as a barrier to gas. As a non-limiting example, the gas barrier layer 118 can be hydrocarbon. The gas barrier layer 118 is a thin layer, and is generally too thin to provide measurable membrane activity. Consequently, a gas barrier layer 118 of hydrocarbon, for example, could not be used with a fuel such as methanol, as the methanol would dissolve the thin gas barrier layer 118. By keeping the gas barrier layer 118 thin, the weight and thickness of the membrane electrode assembly are not sufficiently increased so that the overall weight and thickness of the fuel cell are not negatively impacted. It is also noted that simply mixing hydrocarbon in with an ionomer during fabrication of a membrane will not achieve the objective of providing a barrier for crossover gas.

As another non-limiting example, the gas barrier layer 118 can be a cross-linked material, such as cross-linked perfluorosulfonic acid material. Cross-linked material allows for proton passage but blocks gas from crossing the polymer electrolyte membrane 116. In typical perfluorosulfonic acid membranes, water causes phase separation, which rearranges the chains, allowing for the passage of water and gas. Cross-linking the chains prevents rearrangement of the chains, which prevents fluid crossover. However, cross-linked perfluorosulfonic membranes alone cannot be used as a polymer electrolyte membrane because they become physically brittle, rigid, and water transport resistant. When a cross-linked perfluorosulfonic membrane is used in combination with a noncross-linked perfluorosulfonic membrane, the cross-linked perfluorosulfonic membrane can function as a gas barrier layer without being brittle, rigid and water transport resistant as it is of a low thickness.

The thickness of the gas barrier layer 118 will depend on the membrane electrode assembly design and fuel cell requirements. However, the gas barrier layer 118 is thinner than the polymer electrolyte membrane 116 as the gas barrier layer 118 reduces gas crossover but must also provide low ohmic resistance. The thickness of the gas barrier layer 118 can be chosen based on a current chemical durability target, such as 500 hours. The thickness of the gas barrier layer 118 should be as small as possible to achieve the current chemical durability target. As a non-limiting example, perfluorosulfonic acid membranes can have a thickness of 20-30 microns. The gas barrier layer 118 will have a thickness of less than 20-30 microns.

As illustrated in FIG. 4, another embodiment of a fuel cell 200 has a membrane electrode assembly 210 that includes an additional gas barrier layer 218 between the polymer electrolyte membrane 116 and the cathode catalyst layer 114. The additional gas barrier layer 218 is formed from the proton conductive material and is configured to prevent crossover of oxidant 122 through the polymer electrolyte membrane 116 to the anode catalyst layer 112, as illustrated in FIG. 4.

When one of the electrodes of a membrane electrode assembly is a hydrocarbon-based electrode and only one gas barrier layer 118 is to be included, the gas barrier layer 118 should be positioned between the membrane 116 and the hydrocarbon-based electrode.

Methods of preparing the membrane electrode assemblies disclosed herein are also provided. One method of preparing a membrane electrode assembly is illustrated in the flow diagram of FIG. 5. To prepare the membrane electrode assembly shown, for example, in FIG. 3, the gas barrier layer 118 is applied onto an anode side of the polymer electrolyte membrane 116 in step S1. The anode electrode 112 is applied onto the gas barrier layer 118 in step S2, and the cathode electrode 114 is applied onto a cathode side of the polymer electrolyte membrane 116 in step S3.

As a non-limiting example, the gas barrier layer 118 can be hot pressed with the polymer electrolyte membrane 116 in step S1.

The anode electrode 112 can be applied onto the gas barrier layer 118 in step S2 by spraying anode catalyst material onto the gas barrier layer 118. The cathode electrode 114 can be applied to the polymer electrolyte membrane 116 in step S3 by spraying a cathode catalyst material onto the cathode side of the polymer electrolyte membrane 116. Other methods of applying catalyst material known to those skilled in the art can also be used.

Alternatively, the anode electrode 114 can be applied in step S2 by providing an anode gas diffusion electrode to an anode side of the polymer electrolyte membrane 116 having the gas barrier layer 118. In step S3, a cathode gas diffusion electrode is provided to a cathode side of the polymer electrolyte membrane 116. The anode gas diffusion layer, cathode gas diffusion layer and the membrane 116 with the gas barrier layer 118 can be hot pressed, as a non-limiting example.

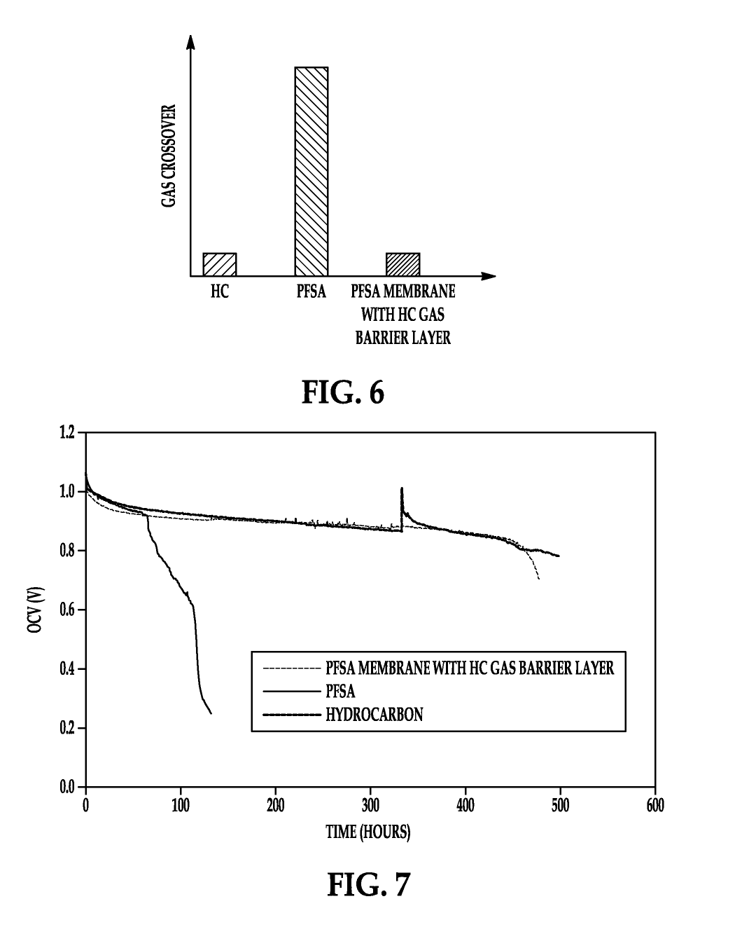

An embodiment of a membrane electrode assembly was prepared by hot-pressing a gas barrier layer to a PFSA membrane. The gas barrier layer bonds well to the PFSA membrane, and no sign of delamination was detected. In-situ oxygen and hydrogen crossover measurements were taken and compared in FIG. 6. FIG. 6 is a graph illustrating the amount of gas crossover for a hydrocarbon (HC) membrane, a perfluorosulfonic acid (PFSA) membrane and the prepared PFSA membrane with a gas barrier layer comprising hydrocarbon. As shown, the PFSA membrane with the gas barrier layer showed crossover almost as low as the crossover measured with a hydrocarbon membrane.

FIG. 7 is a graph illustrating the chemical durability of each of a hydrocarbon (HC) membrane, a PFSA membrane and the prepared PFSA membrane with a gas barrier layer comprising hydrocarbon under an open circuit voltage (OCV) hold test at 90° C. and 30% RH over 500 hours. As FIG. 7 illustrates, the chemical durability of the PFSA membrane with a gas barrier layer is as good as the chemical durability of a hydrocarbon membrane up until about 460 hours, at which point the chemical durability begins to fall. The chemical durability of the PFSA membrane with a gas barrier layer far outperformed the PFSA membrane, which began to lose durability after only about 80 hours.

It is appreciated that certain features of the membrane electrode assemblies, fuel cells and methods, which are, for clarity, described in the context of separate embodiments, may also be provided in combination in a single embodiment. Conversely, various features of the membrane electrode assemblies, fuel cells and methods, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems. In addition, all sub-combinations listed in the embodiments describing such variables are also specifically embraced by the present membrane electrode assemblies, fuel cells and methods and are disclosed herein just as if each and every such sub-combination was individually and explicitly disclosed herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present sensors and methods. Any recited method can be carried out in the order of events recited or in any other order which is logically possible.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A membrane electrode assembly for a fuel cell comprising:
an anode catalyst layer;
a cathode catalyst layer;
a polymer electrolyte membrane between the anode catalyst layer and the cathode catalyst layer; and
a gas barrier layer between the polymer electrolyte membrane and the anode catalyst layer, the gas barrier layer comprising a proton conductive material and configured to prevent crossover of gas through the polymer electrolyte membrane to the cathode catalyst layer.

2. The membrane electrode assembly of claim 1, wherein the gas barrier layer is further configured to prevent oxidant from contacting the anode catalyst layer.

3. The membrane electrode assembly of claim 1, wherein the polymer electrolyte membrane is a perfluorosulfonic acid membrane.

4. The membrane electrode assembly of claim 1, wherein the proton conductive material of the gas barrier layer is hydrocarbon.

5. The membrane electrode assembly of claim 1 further comprising:
an additional gas barrier layer between the polymer electrolyte membrane and the cathode catalyst layer, the additional gas barrier layer comprising the proton conductive material and configured to prevent crossover of oxidant through the polymer electrolyte membrane to the anode catalyst layer.

6. The membrane electrode assembly of claim 5, wherein the proton conductive material of the additional gas barrier layer is hydrocarbon.

7. A membrane electrode assembly for a fuel cell comprising:
an electrode;
a hydrocarbon-based electrode;
a perfluorosulfonic acid membrane between the electrode and the hydrocarbon-based electrode; and
a gas barrier layer between the perfluorosulfonic acid membrane and the hydrocarbon-based electrode, the gas barrier layer comprising a proton conductive material and configured to prevent crossover of gas through the perfluorosulfonic acid membrane to the electrode.

8. The membrane electrode assembly of claim 6, wherein the proton conductive material of the additional gas barrier layer is hydrocarbon.

9. A fuel cell comprising:
a membrane electrode assembly for a fuel cell comprising:
an anode electrode;
a cathode electrode;
a polymer electrolyte membrane between the anode electrode and the cathode electrode; and
a gas barrier layer between the polymer electrolyte membrane and the anode catalyst layer, the gas barrier layer comprising a proton conductive material;
a fuel gas supply in fluid communication with the anode electrode to provide a fuel gas to the anode electrode; and
an oxidant supply in fluid communication with the cathode electrode to provide an oxidant to the cathode electrode, wherein the gas barrier layer is configured to prevent crossover of fuel and oxidant to the cathode electrode and the anode electrode, respectively.

10. The fuel cell of claim 9, wherein the polymer electrolyte membrane is a perfluorosulfonic acid membrane.

11. The fuel cell of claim 9, wherein the proton conductive material of the gas barrier layer is hydrocarbon.

12. The fuel cell of claim 9, wherein the fuel is hydrogen.

13. The fuel cell of claim 9, wherein the oxidant is at least one of oxygen and air.

14. The fuel cell of claim 9, wherein the gas barrier layer is a first gas barrier layer and the membrane electrode assembly further comprises:
a second gas barrier layer between the polymer electrolyte membrane and the cathode catalyst layer, the second gas barrier layer comprising the proton conductive material, wherein the first gas barrier layer is configured to prevent fuel crossover across the polymer electrolyte membrane and the second gas barrier layer is configured to prevent oxidant crossover across the polymer electrolyte membrane.

15. The fuel cell of claim 14, wherein the proton conductive material of the first gas barrier layer and the second gas barrier layer is hydrocarbon.

16. A method of preparing a membrane electrode assembly comprising:
applying a gas barrier layer onto an anode side of a polymer electrolyte membrane, wherein the gas barrier layer is a proton conductive material;
applying an anode electrode onto the gas barrier layer; and
applying a cathode electrode onto a cathode side of the polymer electrolyte membrane.

17. The method of claim 16, wherein the proton conductive material of the gas barrier layer is hydrocarbon.

18. The method of claim 16, wherein applying the gas barrier layer comprises hot pressing the gas barrier layer and the polymer electrolyte membrane.

19. The method of claim 16, wherein applying the anode electrode comprises spraying an anode catalyst material onto the gas barrier layer and applying the cathode electrode comprises spraying a cathode catalyst material onto a cathode side of the polymer electrolyte membrane.

20. The method of claim 16, wherein applying the anode electrode and applying the cathode electrode comprises providing an anode gas diffusion electrode to an anode side of the polymer electrolyte membrane having the gas barrier layer, providing a cathode gas diffusion electrode to a cathode side of the polymer electrolyte membrane and hot pressing.
